(19) United States
(12) Patent Application Publication
(10) Pub. No.: US 2026/0003126 A1
(43) Pub. Date: Jan. 1, 2026

(54) OPTICAL COUPLER AND FABRICATION METHOD THEREOF

(71) Applicants: Consorzio Nazionale Interuniversitario per le Telecomunicazioni, Parma (IT); Camgraphic S.r.l., Monza (IT)

(72) Inventors: Luigi Tallone, Paesana (IT); Marco Romagnoli, Milano (IT); Stefano Soresi, Monza (IT); Sara Pascale, Monza (IT); Marco Chiesa, Monza (IT)

(21) Appl. No.: 19/127,022

(22) PCT Filed: Nov. 2, 2023
(86) PCT No.: PCT/EP2023/080603

§ 371 Date: Sep. 16, 2025

(30) Foreign Application Priority Data
Nov. 3, 2022 (IT) 102022000022593

(51) Int. Cl. G02B 6/30; G02B 6/12; G02B 6/122; G02B 6/136

(52) U.S. Cl. CPC G02B 6/305; G02B 6/12002; G02B 6/12004; G02B 6/1228; G02B 6/136; G02B 2006/12038; G02B 2006/1204; G02B 2006/12061; G02B 2006/12097; G02B 2006/12147

(57) ABSTRACT

There is provided an optical coupler comprising: a first waveguide (100) comprising a tapering portion (101); an intermediate waveguide (200) comprising: a first tapering portion (201) at a first end of the intermediate waveguide (200), the first tapering portion (201) of the intermediate waveguide (200) being optically coupled to the tapering portion (101) of the first waveguide (100), and a second tapering portion (202) at a second end of the intermediate waveguide (200); and a second waveguide (300), wherein the second tapering portion (201) of the intermediate waveguide (200) is optically coupled to the second waveguide (300). A method for fabricating the optical coupler is also provided.

### FIELD OF THE INVENTION

The present invention relates to an optical coupler. In particular, the present invention relates to an optical coupler for connecting optical waveguides having different optical modes.

### BACKGROUND OF THE INVENTION

Despite the increasing maturity of photonic and optoelectronic technologies, coupling of optical waveguides between waveguides with minimal coupling losses still remains challenging. In particular, optical coupling between a chip and an external connection, such as photonic chip-to-fibre or fibre-to-photonic chip interfaces, requires conversion between optical modes of significantly different dimensions. For example, an interface between a silicon-on-insulator (SOI) waveguide and an optical fibre would require mode conversion between the mode of the optical fibre, which can be ˜10 μm, and the mode of SOI waveguide, which can have sub-micron dimensions (e.g. hundreds of nm). Such a large mismatch between the modes, without a mode converter (i.e. a spot-size converter), typically leads to a significant optical loss, which can be detrimental to the efficiency of the chip.

One existing solution is a grating coupler which comprises a periodic structure that couples light between a chip and an optical fibre. Using such a grating structure for optical coupling provides an advantage that it can be easily fabricated using simple and inexpensive process (e.g. by etching a silicon-side surface of an SOI substrate). However, optical coupling efficiency that can be achieved using a grating coupler is known to be relatively low due to high level of optical loss (>2 dB). In addition, the grating couplers have a relatively narrow wavelength bandwidth (typically on the order of 10 s of nm), which can be problematic for wideband or multiband applications. Furthermore, grating couplers require fibre optic cores axis to be aligned substantially perpendicularly to the plane of the grating structure. Such configurations, inevitably increases the form factor of the chip, limiting the compactness of the overall packaging of the device.

U.S. Ser. No. 10/921,518B2 discloses an apparatus for coupling optical fibre to a photonic chip, including: a low index contrast waveguide overlapping a region of a photonic chip, a high index contrast waveguide at least partially embedded within the overlapped region of the photonic chip, where the high index contrast waveguide comprises a tapered region and a fixed-width routing region, and where the tapered region comprises an adiabatic crossing region and a wide waveguide region connecting the adiabatic crossing region and the fixed-width routing region. This type of couplers have shown to have lower optical losses than grating couplers. However, they typically occupy relatively large area on the chip, which may not be a major concern for a low-cost chip, such as a SOI chip, it can be a significant disadvantage if the chip is a high-cost chip, such as a lithium niobate-on-insulator (LNOI) chip.

There also exists various other existing on-chip spot-size converters (SSCs) having a mode-size expanding section. However, such on-chip integrated SSC require complex design in order to prevent undesirable energy transfer into the substrate.

### SUMMARY OF THE INVENTION

The invention is defined by the claims to which reference should now be made. Preferred features are outlined in the dependent claims.

According to a first aspect of the invention, an optical coupler is provided, the optical coupler comprising: a first waveguide comprising a tapering portion; an intermediate waveguide comprising: a first tapering portion at a first end of the intermediate waveguide, the first tapering portion of the intermediate waveguide being optically coupled to the tapering portion of the first waveguide, and a second tapering portion at a second end of the intermediate waveguide; and a second waveguide, wherein the second tapering portion of the intermediate waveguide is optically coupled to the second waveguide.

Optionally, an optical signal may propagate from the first waveguide to the second waveguide via the intermediate waveguide.

Optionally, an optical signal may propagates from the second waveguide to the first waveguide via the intermediate waveguide.

Optionally, at least a part of the first waveguide may be adjacent to a dielectric layer, at least a part of the dielectric layer being located between the at least a part of the first waveguide and a first substrate.

Optionally, the first substrate may comprise silicon.

Optionally, the first substrate may be a part of a chip, the chip having one or more electronic or optical components formed thereon.

Optionally, the dielectric layer ma comprise one or more of: SiO₂, Si₃N₄, and other dielectric material such as polymer.

Optionally, the dielectric layer may be in the form of buried oxide (BOX).

Optionally, the first waveguide may comprise silicon.

Optionally, the first waveguide may comprise lithium niobate.

Optionally, the first waveguide may comprise a first portion having a first thickness and a second portion having a second thickness, the second thickness being greater than the first thickness.

Optionally, the second portion may have an elevated surface relative to the first portion.

Optionally, the second portion may have a tapering profile extending toward the second waveguide.

Optionally, the first waveguide may be a rib waveguide.

Optionally, the optical coupler may comprise an adhesive layer between at least a part of the first waveguide and at least a part of the intermediate waveguide, wherein the tapering portion of the first waveguide and the first tapering portion of the intermediate waveguide at least partially overlap.

Optionally, at least a part of the first waveguide and at least a part of the intermediate waveguide may be coupled by means of one or more releasable connecting means, wherein the tapering portion of the first waveguide and the first tapering portion of the intermediate waveguide at least partially overlap.

Optionally, the tapering portion of the first waveguide and the first tapering portion of the intermediate waveguide may have the same length, Optionally, the tapering portion of the first waveguide and the first tapering portion of the intermediate waveguide may overlap along their lengths.

Optionally, the optical coupler may comprise a spacer layer between the tapering portion of the first waveguide and the first tapering portion of the intermediate waveguide, preferably wherein the spacer layer has a refractive index equal to that of the dielectric layer located adjacent to the first waveguide, and further preferably wherein the spacer layer has a thickness between 0.4 μm and 1.9 μm.

Optionally, the space layer may be the adhesive layer.

Optionally, the dimensions and tapering profiles of one or more of the tapering portions of the first and intermediate waveguides may be determined to maximise one or more of: an optical coupling efficiency between the first waveguide and the intermediate waveguide, and an optical coupling efficiency between the intermediate waveguide and the second waveguide.

Optionally, relative positions of the tapering portion of the first waveguide and the first tapering portion of the intermediate waveguide may be determined to minimise optical coupling loss between the tapering portion of the first waveguide and the first tapering portion of the intermediate waveguide

Optionally, the dimensions, tapering profiles, and the relative positions of the tapering portion of the first waveguide and the first tapering portion of the intermediate waveguide are determined so that the optical coupling loss between the tapering portion of the first waveguide and the first tapering portion of the intermediate waveguide is lower than 3 dB.

Optionally, the intermediate waveguide may comprise Si₃N₄.

Optionally, at least a part of the intermediate waveguide may be adjacent to one or more cladding layers, at least one of the cladding layer being located between the at least a part of the intermediate waveguide and a second substrate, preferably wherein the cladding layer located between the at least a part of the intermediate waveguide and the second substrate has a thickness greater than 15 μm.

Optionally, the second substrate may comprise silicon.

Optionally, the second substrate, the one or more cladding layer(s), and the intermediate waveguide may be packaged as a flip-chip.

Optionally, the cladding layer may comprise one or more of: SiO₂, Si₃N₄, and other dielectric material such as polymer.

Optionally, the refractive index of the first waveguide may be higher than that of the intermediate waveguide.

Optionally, the second waveguide may comprise a first portion having a first thickness and a second portion having a second thickness, the second thickness being greater than the first thickness, wherein the second tapering portion of the intermediate waveguide is coupled to the first portion of the second waveguide.

Optionally, at least one of the cladding layers may be adjacent to the second tapering portion of the intermediate waveguide and the second waveguide.

Optionally, the flip-chip may further comprise the second waveguide.

Optionally, the second waveguide may comprise SiO₂, and at least one type of dopants, such as Ge and P, for increasing the refractive index of the second waveguide.

Optionally, the second waveguide may be configured to be coupled to an external optical transmission means, such as an optical fibre, and the type of the dopants and the doping concentration are determined so that the refractive index of the second waveguide has 0.4-0.7% contrast with that of the external optical transmission means.

Optionally, the dopants may be Ge dopants.

Optionally, the external optical transmission means may comprise SiO₂.

Optionally, the dimensions and tapering profiles of the second tapering portion of the intermediate waveguide may be determined to maximise the optical coupling efficiency between the second tapering portion of the intermediate waveguide and the second waveguide.

Optionally, relative positions of the second tapering portion of the intermediate waveguide and the second waveguide may be determined to minimise optical coupling loss between the second tapering portion of the intermediate waveguide and the second waveguide.

Optionally, the dimensions and tapering profiles of the second tapering portion of the intermediate waveguide, and its position relative to the second waveguide may be determined so that the optical coupling loss between the second tapering portion of the intermediate waveguide and the second waveguide is lower than 3 dB.

Optionally, the optical coupler may be configured to function as a spot size converter, wherein the optical signal has a first mode in the first waveguide and a second mode in the second waveguide, the first mode being smaller than the second mode.

Optionally, the external optical transmission means and/or the second waveguide may be pluggable with the first waveguide using the one or more releasable connecting means.

Optionally, the intermediate waveguide and the second waveguide may be optically and/or physically coupled so that the coupling takes place spaced apart from the first waveguide.

Optionally, the first waveguide and the second waveguide may not be positioned on a same substrate.

Optionally, the first waveguide and at least a part of the intermediate waveguide may not be positioned on the same substrate.

According to a second aspect of the invention, a method for fabricating an optical coupler is provided, the method comprising steps of: providing a first substrate; forming a dielectric layer on the first substrate; forming a layer of a first waveguide material on the dielectric layer; partially etching the layer of the first waveguide material to form a tapering portion; providing a second substrate; forming a cladding layer on the second substrate; forming a layer of an intermediate waveguide material on the cladding layer; partially etching the layer of the intermediate waveguide material to form a first tapering portion and a second tapering portion; forming a layer of a second waveguide material covering the second tapering portion of the intermediate waveguide and a part of the cladding layer; and coupling the first waveguide and the intermediate waveguide so that the distance between the first waveguide and the intermediate waveguide is smaller than the distance between the first waveguide and the second substrate.

Optionally, the method may further comprise a step of etching the layer of the first waveguide to form a portion having a first thickness and a portion having a second thickness, thereby forming a rib waveguide structure.

Optionally, the step of coupling the first waveguide and the intermediate waveguide may be performed by attaching the intermediate waveguide to the first waveguide via an adhesive layer.

Optionally, coupling the first waveguide and the intermediate waveguide may be performed by attaching the intermediate waveguide to the first waveguide by means of one or more releasable connecting means.

Optionally, the step of coupling the first waveguide and the intermediate waveguide may comprise a step of aligning the tapering portion of the first waveguide and the first tapering portion of the intermediate waveguide by using a mask aligner.

Optionally, the external optical transmission means and/or the second waveguide may be pluggable with the first waveguide using the one or more releasable connecting means.

### BRIEF DESCRIPTION OF THE DRAWINGS

FIG. 1A shows a perspective view of an optical coupler, according to an embodiment;

FIG. 1B shows a top view of an optical coupler, according to an embodiment;

FIG. 1C shows a cross-sectional view of an optical coupler, according to an embodiment;

FIG. 2A shows a top view of a section of an optical coupler in which a first waveguide and an intermediate waveguide partially overlap, according to an embodiment;

FIG. 2B shows a cross-sectional view of a section of an optical coupler in which a first waveguide and an intermediate waveguide partially overlap, according to an embodiment;

FIG. 3A shows a top view of a section of an optical coupler in which an intermediate waveguide and a second waveguide partially overlap, according to an embodiment;

FIG. 3B shows a cross-sectional view of a section of an optical coupler in which an intermediate waveguide and a second waveguide partially overlap, according to an embodiment;

FIG. 4 is a schematic diagram showing how a chip comprising an intermediate waveguide can be releasably attached to a chip comprising a first waveguide using one or more releasable connecting means, according to an embodiment;

FIG. 5 is an graph (left) showing an exemplary taper profile determined using Equation 1, and an inset (right) showing an exemplary tapered portion determined using Equation 1; and

FIG. 6 is a flow chart showing steps of fabricating an optical coupler according to an embodiment.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

As used herein, the term “spot-size converter (SSC)” means an optical component that connect waveguides with optical modes of different dimensions. The wording “spot” of the term “spot-size converter” does not imply that optical mode(s) of the light travelling through the spot-size converter need(s) to resemble a “spot” in terms of its/their dimension(s) and/or the shape(s).

Generally embodiments of the invention provides an optical coupler comprising a first waveguide, an intermediate waveguide, and a second waveguide. The first waveguide comprises a tapering portion. The intermediate waveguide comprises a first tapering portion at a first end of the intermediate waveguide. The first tapering portion of the intermediate waveguide is optically coupled to the tapering portion of the first waveguide. The intermediate waveguide also comprises a second tapering portion at a second end of the intermediate waveguide. The second tapering portion of the intermediate waveguide is optically coupled to the second waveguide.

The optical coupler may be configured to function as a SSC, in which wherein the optical signal has a first mode in the first waveguide and a second mode in the second waveguide, the first mode being smaller than the second mode.

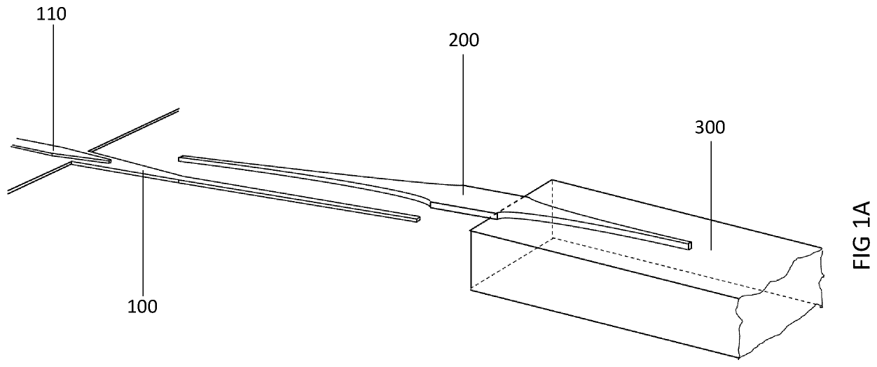

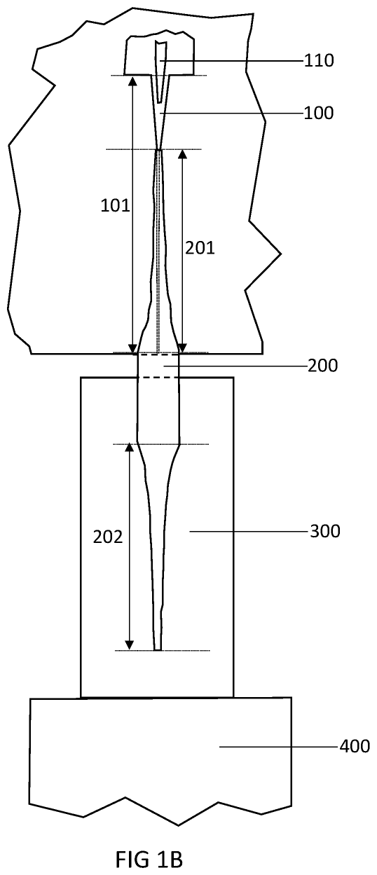

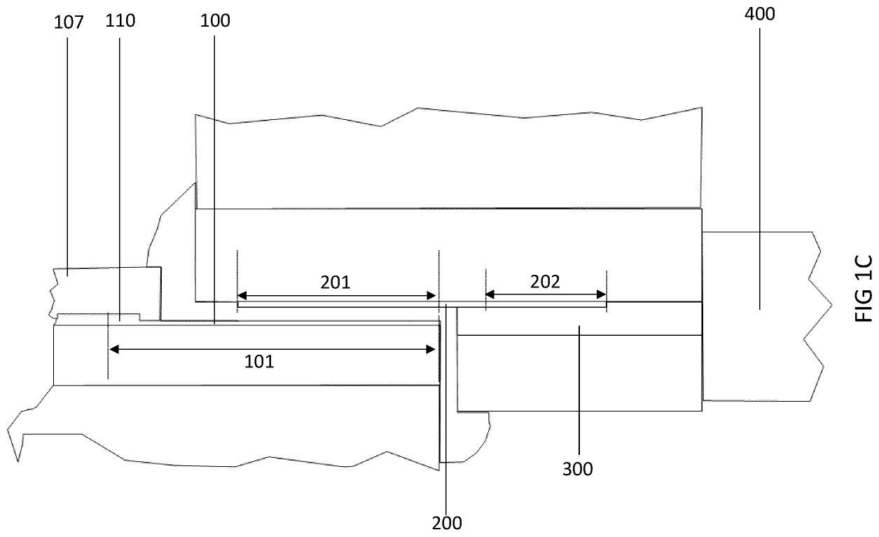

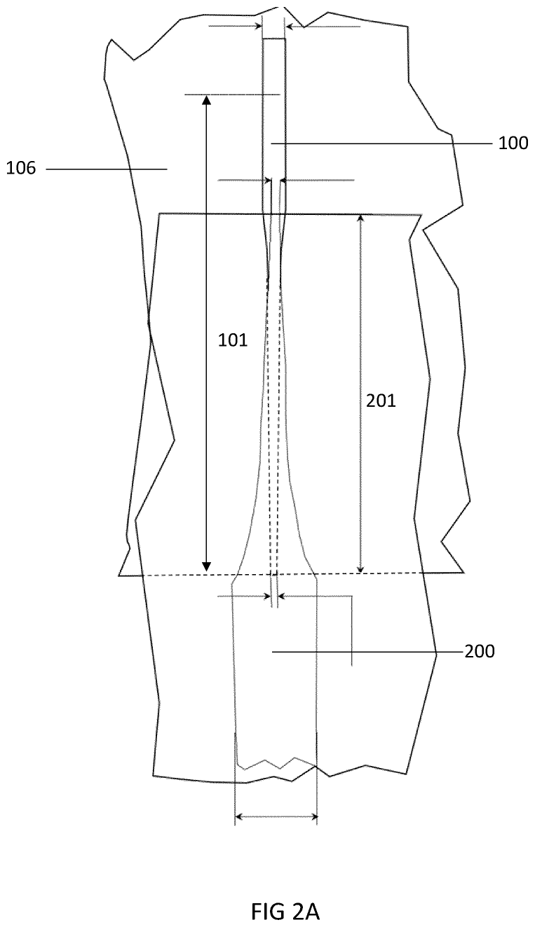

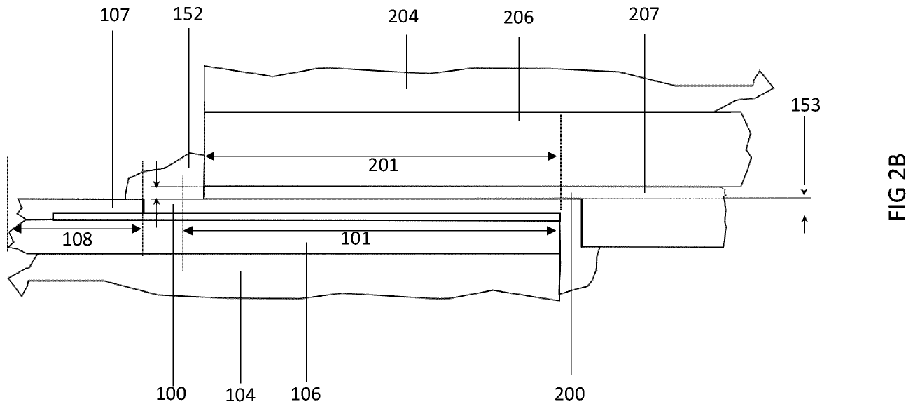

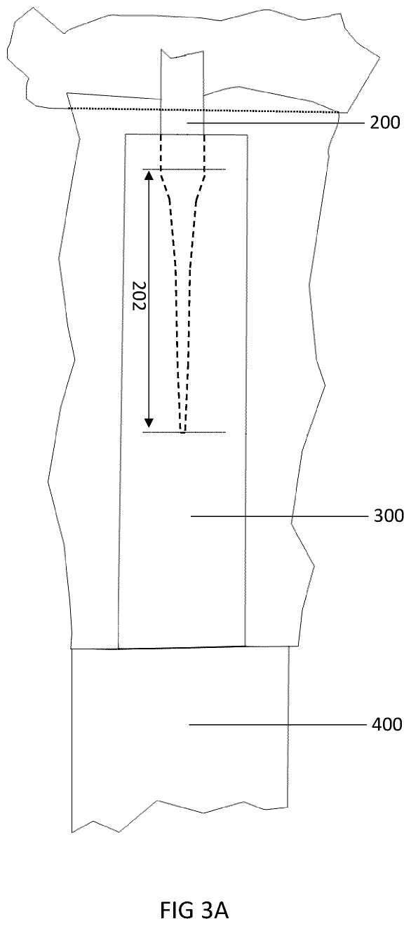

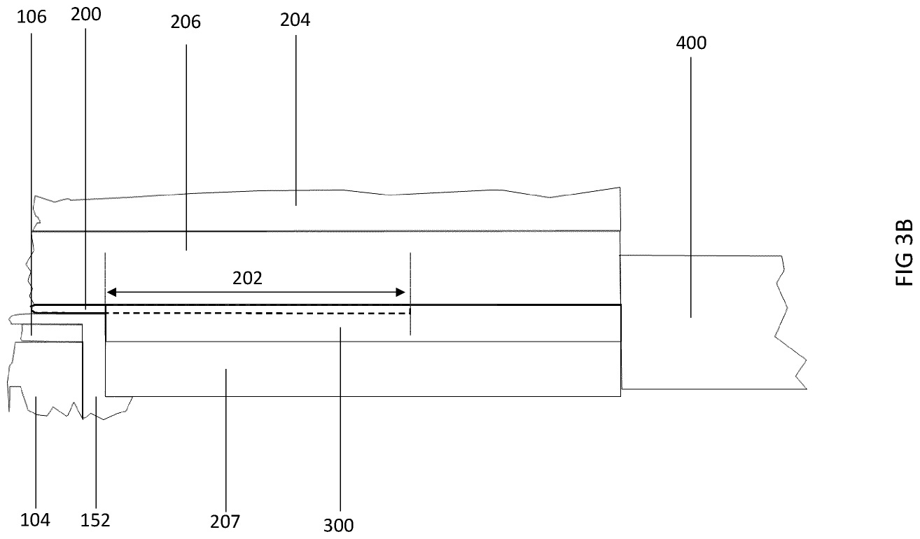

Embodiments of the optical coupler will be discussed with reference to example figures. FIG. 1A to FIG. 1C illustrate an exemplary optical coupler comprising the first waveguide, the intermediate waveguide, and the second waveguide. FIG. 2A and FIG. 2B illustrate a section of an exemplary optical coupler in which the first waveguide and the intermediate waveguide partially overlap. FIG. 3A and FIG. 3B illustrate a section of an exemplary optical coupler in which the intermediate waveguide and the second waveguide partially overlap.

As illustrated in FIG. 1A to FIG. 1C, the optical coupler comprises a first waveguide 100, an intermediate waveguide 200, and a second waveguide 300. The first waveguide 100 comprises a tapering portion 101. The intermediate waveguide 200 comprises a first tapering portion 201 at its first end. The first tapering portion 201 of the intermediate waveguide 200 is optically coupled to the tapering portion 101 of the first waveguide 101. The intermediate waveguide 200 also comprises a second tapering portion 202 at its second end. The second tapering portion 202 of the intermediate waveguide 200 is optically coupled to the second waveguide 300.

The optical coupler may be configured to receive an optical input (i.e. light) from one end, or two optical inputs from two ends. For example, an optical input from a light source, such as an on-chip light source, may be received at or near the first end of the first waveguide 100. In such cases, the received light propagates from the first waveguide 100 to the second waveguide 300 via intermediate waveguide 200. The second waveguide 300 may have a first end extending toward the first waveguide 100 and a second end extending away from the first end. When the second waveguide 300 receives the light from the second tapering portion 202 of the intermediate waveguide 200, the light may propagate to the second end of the second waveguide 300 of the second waveguide 300. The second end of the second waveguide 300 may be optically coupled to an external waveguide 400, such as an optical fibre, enabling the light to further propagate through the external waveguide 400.

Alternatively, an external waveguide 400, such an optical fibre, carrying an optical input from an external light source may be optically coupled to the second end of the second waveguide 300. In such cases, the light received at the second end of the second waveguide 300 propagates to the first waveguide 100 via the intermediate waveguide 200. The first waveguide 100 may have a second end extending toward the second waveguide 300 and a first end extending away from the second end. When the tapering portion 101 of the first waveguide 100 receives the light from the first tapering portion 201 of the intermediate waveguide 200, the light may propagate to the first end of the first waveguide 100. The first waveguide 100 may be optically coupled to an on-chip waveguide, enabling the light to further propagate through the on-chip waveguide.

Preferably, the optical coupler may be configured to allow bi-directional transmissions. In such cases, the optical coupler may be configured to receive a first optical input at the first waveguide 100 and a second optical input at the second waveguide 300. Such bi-directional optical transmission may be simultaneous, having optical signals travelling in the two directions (i.e. from the first waveguide 100 to the second waveguide 300, and from second waveguide 300 to the first waveguide 100) at the same time. Alternatively, the bi-directional optical transmission may be asynchronous, having an optical signal travelling in one direction at a time. The optical signal(s) may be data signal(s) for data transfer, and/or for optical energy transfer.

FIG. 2A and FIG. 2B, respectively, illustrate a top view and a cross-sectional view of a section of an exemplary optical coupler in which the first waveguide 100 and the intermediate waveguide 200 partially overlap. The optical coupler may comprise a first substrate 104 and a dielectric layer 106, the dielectric layer 106 being located between the first waveguide 100 and the first substrate 104. Optionally, the first waveguide 100 may have a portion 108 that is sandwiched between the dielectric layer 106 and an additional dielectric layer 107. In the example shown in FIG. 2B the said sandwiched portion 108 is located away from the second end of the first waveguide 100.

In the example shown in FIG. 2A and FIG. 2B, the dielectric layer 106 is in the form of buried oxide (BOX) and the first substrate 104 is a silicon substrate, thereby forming an SOI structure. However, in other embodiments, the dielectric layer 106 may be in any suitable form, and/or may comprise one or more of: SiO₂, Si₃N₄, and other dielectric material such as polymer. Similarly, although the first substrate 104 in the example shown in FIG. 2A and FIG. 2B is a silicon substrate, in other embodiments, the first substrate 104 may be a substrate comprising one or more of: silicon, germanium, and Ill-V semiconductor materials. For example, the first substrate 104 may be: a silicon substrate, a SiO₂ substrate, a Si₃N₄ substrate, a silicon substrate comprising one or more oxide layers (e.g. SiO₂), and a silicon substrate comprising one or more nitride layer (e.g. Si₃N₄). Furthermore, the first substrate 104 may further comprise one or more dopant(s), such as boron, indium, phosphorous, arsenic, and antimony.

The first waveguide 100 may be a waveguide comprising silicon and/or lithium niobate. For example, the first waveguide 100 may be a Si waveguide or a LiNbO₃ waveguide.

As can be seen in FIG. 1A to FIG. 1C (however, not shown in FIG. 2A and FIG. 2B), the first waveguide 100 may comprise a first portion having a first thickness and a second portion 110 having a second thickness, the second thickness being greater than the first thickness. In such cases, the second portion 108 of the first waveguide 108 may have an elevated surface relative to that of the first portion. The second portion 108 of the first waveguide 100 may have a tapering profile extending toward the second waveguide. As a result, the first waveguide 100 may form a rib waveguide structure.

Optionally, the first substrate 104 and/or the dielectric layer 106 may from a part of a chip that has one or more electronic or optical components formed thereon. For example, the chip may be a photonic integrated circuit (PIC). Optionally, the first waveguide 100 may also form a part of the chip. One of the components formed on the chip may optionally be an on-chip light source. In such cases, the on-chip light source may be connected to the first waveguide 100 to provide an optical input. Optionally, the connection between the on-chip light source and the first waveguide 100 may be made via one or more electronic or optical components, such as a filter and modulator.

Energy coupling between the first waveguide 100 and intermediate waveguide 200 may be achieved by bring the tapering portion 101 of the first waveguide 100 and the first tapering portion 201 of the intermediate waveguide 200 in a manner that the two tapering portions 101, 202 at least partially overlap. Preferably, as shown in FIG. 1 and FIG. 2, the lengths of the two tapering portions 101, 202 may be of the same or approximately the same, and completely or substantially overlap. This may be beneficial for maximising the optical coupling efficiency at the interface of the first waveguide 100 and intermediate waveguide 200. Preferably, the lateral misalignment between the central axes of the tapering portion 101 of the first waveguide 100 and the first tapering portion 201 of the intermediate waveguide 200 may be smaller than 1.5 μm in order to minimise its effect on the coupling efficiency. Preferably, the refractive index of the first waveguide 100 may be higher than that of the intermediate waveguide 200

In the example shown in FIG. 2B, the tapering portion 101 of the first waveguide 100 and the first tapering portion 201 of the intermediate waveguide 200 are attached together via an adhesive layer 152.

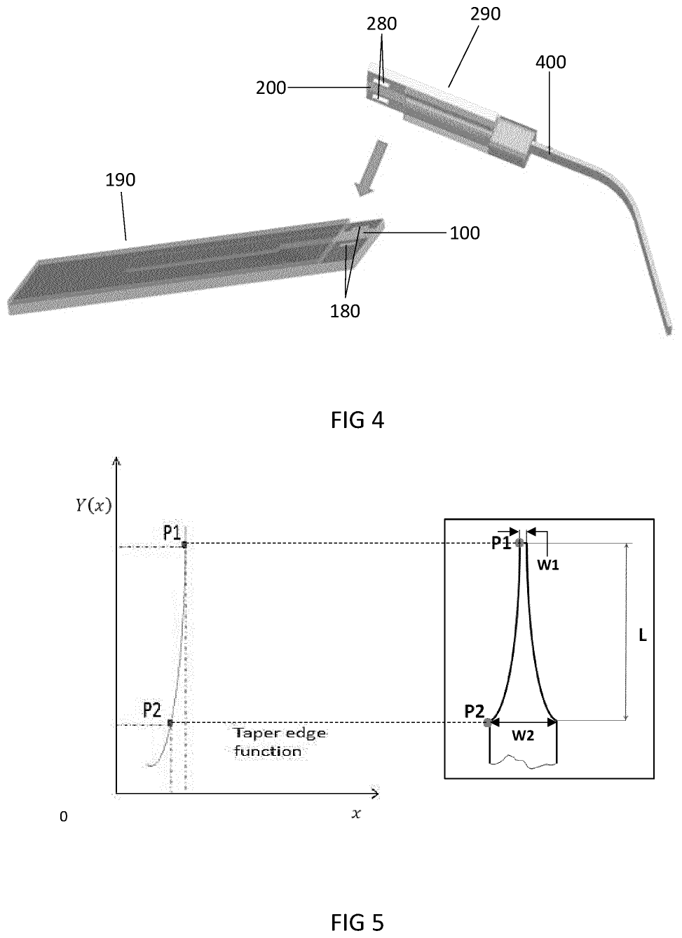

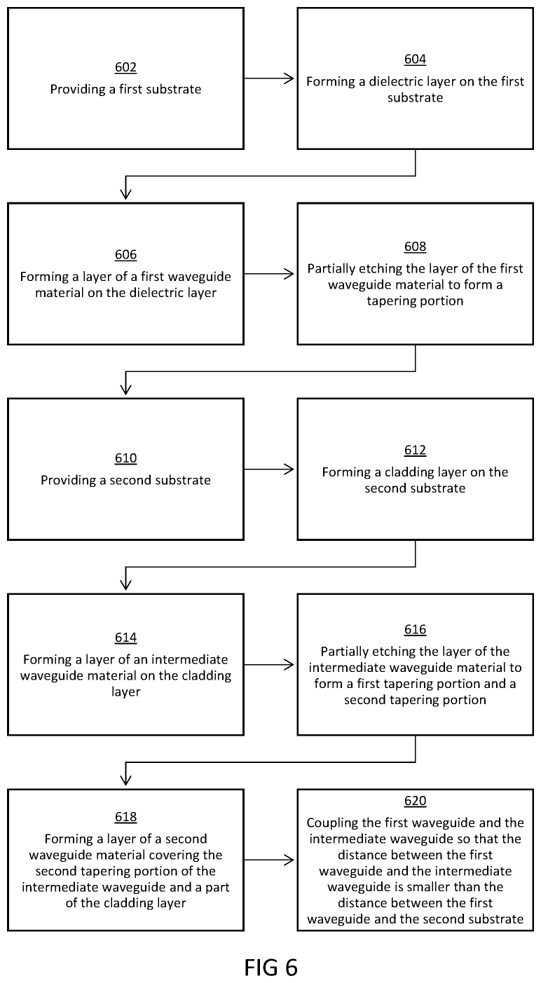

Alternatively, one or more releasable connecting means 180, 280 may be used to attached the tapering portion 101 of the first waveguide 100 and the first tapering portion 201 of the intermediate waveguide 200. For example, as shown in FIG. 4, a first chip 190 comprising the first waveguide 100 may comprise one or more releasable connecting means 180, and a second chip 290 comprising the intermediate waveguide 200 may comprise one or more releasable connecting means 280. In such cases, the releasable connecting means 180, 280 are positioned in a manner that, when the releasable connecting means 280 of the second chip is received by the releasable connecting means 180 of the first chip 190, the first waveguide 100 and the intermediate waveguide 200 are positioned to achieve a desired level of optical coupling efficiency. The releasable connecting means 180, 280 may be any of connecting means to enable the two chips (190, 290) to be attached in a releasable manner. For example, the releasable connecting means 180, 280 may be an optical connector having fixing means such as one or more screws, latching mechanisms, magnets, and/or bayonets. The releasable connecting means 180, 280 may also be gendered, in which case, connecting means of a first gender may be mounted on the first chip 190, and connecting means of a second gender may be mounted on the second chip 290. The releasable connecting means 180, 280 may optionally further comprise one or more alignment features, such as grooves, alignment pins and bores.

Such configurations utilising the releasable connecting means 180, 280 may be particularly useful when the first chip 190 needs to be soldered on a PCB. Doing so would normally require a thermal reflow at a high temperature that may deteriorate fibre optic polymer coating and the adhesive layer 152. The releasable connecting means 180, 280 provides a solution to this issue by allowing the fibre to be connected to the first chip 190 after the thermal reflow process. Furthermore, the releasable connecting means 180, 280 also enables the first chip 190 to be temporarily detached from the second chip 290 for any required further fabrication and/or maintenance. In other words, as shown in FIG. 4, the optical coupler with the releasable connecting means 180, 280 may, in turn, provide a pluggable connector between the external waveguide 400 (e.g. a standard optical fibre) and the second chip 290 (e.g. SOI or LNOI chip).

The releasable connecting means 180, 280 may optionally further comprise one or more indentations to ensure that, when the releasable connecting means 280 of the second chip is received by the releasable connecting means 180 of the first chip 190, the first waveguide 100 and the intermediate waveguide 200 do not make direct contact with each other.

Optionally, the second chip 290 may further comprise the second waveguide 300, as shown in the example of FIG. 4. In such cases, the external waveguide 400, such as an optical fibre, may be connected to the second chip 290 to provide an optical coupling between the external waveguide 400 and the second end of the second waveguide 300.

Optionally, the optical coupler may comprise a spacer layer between the tapering portion 101 of the first waveguide 100 and the first tapering portion 201 of the intermediate waveguide 202. In the example shown in FIG. 4, the adhesive layer 152 may also function as the spacer layer.

In embodiments in which the optical coupling between the first waveguide 100 and the intermediate waveguide 200 is achieved using releasable connecting means 180, 280, one or more spacer layers may be positioned on a surface of the first waveguide 100 and/or a surface of the intermediate waveguide 200 so that, when the releasable connecting means 280 of the second chip is received by the releasable connecting means 180 of the first chip 190, the one or more spacer layers are positioned between the tapering portion 101 of the first waveguide 100 and the first tapering portion 201 of the intermediate waveguide 202.

Preferably, the one or more spacer layers may have a refractive index equal to that of the dielectric layer 106 located adjacent to the first waveguide 100. Preferably, the total thickness 153 of the one or more spacer layers, which corresponds to the distance 153 between the first waveguide 100 and the intermediate waveguide 200, may have a value between 0.4 μm and 1.9 μm.

Preferably, one or more of: the relative positions of the tapering portion 101 of the first waveguide 100 and the first tapering portion 201 of the intermediate waveguide 200; the dimensions of the first tapering portion 201 of the intermediate waveguide 200; and the tapering profile of the first tapering portion 201 of the intermediate waveguide 200 may be determined so that the optical coupling loss between the first waveguide 100 and the intermediate waveguide 200 is lower than 3 dB.

In the examples shown in FIG. 1 to FIG. 3, the intermediate waveguide 200 is a silicon nitride (Si₃N₄) waveguide. However, in other embodiments, the intermediate waveguide 200 may also be made of a material having a similar refractive index as Si₃N₄, such as lithium niobate.

The optical coupler may comprise one or more cladding layers 206, 207 adjacent to the intermediate waveguide 200. The optical coupler may also comprise a second substrate. In the example shown in FIG. 2B, an undercladding layer 206 is located between the intermediate waveguide 200 and the second substrate 204, and the intermediate waveguide 200 is located between the undercladding layer 206 and an overcladding layer 207. Preferably, the overcladding layer 207 may not cover the first tapering portion 201 of the intermediate waveguide 200 to enable efficient optical coupling between the first tapering portion 201 of the intermediate waveguide 200 and the tapering portion 101 of the first waveguide 100.

Preferably, the undercladding layer 206 may have a thickness greater than 15 μm for effective optical isolation between the second waveguide 300 and the second substrate 204. Similarly, the overcladding layer 207 may have a thickness greater than 10 μm. Preferably, the adhesive layer 152 may have the same or similar refractive index as that of the cladding layers 206, 207.

In the example shown in FIG. 2A and FIG. 2B, the cladding layers 206, 207 are made of SiO₂. However, in other embodiments, the cladding layers 206, 207 may comprise any one or more of: SiO₂, Si₃N₄, and other dielectric material such as polymer. Similarly, the second substrate 204 in the example shown in FIG. 2A and FIG. 2B is a silicon substrate. However, in other embodiments, the second substrate 204 may be a substrate comprising one or more of: silicon, germanium, and Ill-V semiconductor materials. For example, the second substrate 204 may be: a silicon substrate, a SiO₂ substrate, a Si₃N₄ substrate, a silicon substrate comprising one or more oxide layers (e.g. SiO₂), and a silicon substrate comprising one or more nitride layer (e.g. Si₃N₄). Furthermore, the second substrate 204 may further comprise one or more dopant(s), such as boron, indium, phosphorous, arsenic, and antimony.

Optionally, at least one of: the second substrate 204 and the cladding layers 206, 207 may from a part of a chip 290. Optionally, the chip may be a flip-chip configured to be mounted to the first chip 190 as explained above in relation to the example shown in FIG. 4. Optionally, the second substrate 204, the one or more cladding layer(s) 206, 207, and the intermediate waveguide 200 may be packaged as a single flip-chip 290.

FIG. 3A and FIG. 3B, respectively, illustrates a top view and a cross-sectional view of a section of an exemplary optical coupler in which the intermediate waveguide 200 and the second waveguide 300 partially overlap. As shown in FIG. 3B, the second waveguide 300 may comprise a first portion having a first thickness and a second portion having a second thickness, the second thickness being greater than the first thickness. The first portion of the second waveguide 300 corresponds to a portion of the second waveguide 300 that is in contact with the second tapering portion 202 of the intermediate waveguide 200. Therefore, the second tapering portion 202 of the intermediate waveguide 200 may be partially embedded in the second waveguide 300.

In the examples shown in FIG. 1 to FIG. 3, the second waveguide 300 is a Ge-doped SiO₂. However, in other embodiments, the second waveguide 200 may comprise SiO₂ and at least one type of dopants for increasing the refractive index, such as Ge and P. Preferably, the refractive index of the second waveguide 300 is determined so that the refractive index of the second waveguide 300 has 0.4-0.7% contrast with that of the external optical transmission means 400 coupled to the second end of the second waveguide 300. The optical transmission means 400 may be an optical fibre cable having a core. The optical fibre core material may comprise SiO₂.

Preferably, one or more of: the relative positions of the second tapering portion 202 of the intermediate waveguide 200 and the second waveguide 300; the dimensions of the second tapering portion 202 of the intermediate waveguide 200; and the tapering profile of the second tapering portion 202 of the intermediate waveguide 200 may be determined so that the optical coupling loss between the intermediate waveguide 200 and the second waveguide 300 is lower than 3 dB.

Optionally, dimensions and tapering profiles of the first and second tapering portions 201, 202 of the intermediate waveguide 200 may be determined in a way to achieve a desired level of coupling efficiency (e.g. to maximise the coupling efficiency) between the first waveguide 100 and the intermediate waveguide 200, and/or between the intermediate waveguide 200 and the second waveguide 300.

For example, the tapering profiles of the tapering portions 201, 202 of the intermediate waveguide 200 may be determined by numerical simulations taking Equation 1 below into consideration.

$$Y ( x ) = A * {e}^{- b * ( x - xc )} + Yc \qquad Equation 1$$

$$A = \frac{{y}_{1} - {y}_{2}}{{e}^{- b * ( {x}_{1} - xc )} - {e}^{- b * ( {x}_{2} - xc )}}$$

$$Yc = {y}_{2} - A * {e}^{- b * ( {x}_{2} - xc )}$$

As shown in the graph (left) and inset (right) shown in FIG. 5, the vertical axis of the graph Y(x) corresponds to the direction along the length of a tapered portion, and the horizontal axis of the graph x corresponds to the direction along the width of the same tapered portion. P1 and P2 on the graph corresponds to two ends of a tapering curve of the tapering portion, P1 being a distal end point of the tapering curve at which the tapering portion has the smallest width, and P2 being a proximal end point of the tapering curve at which the tapering portion has the largest width. The length L of the tapered portion corresponds to the difference between Y(x) values of P1 and P2 on the graph. As shown in FIG. 5, the distal end of the tapering portion may optionally have an end face having a flat profile and a width W1. Preferably, one or more of the tapering portions 101, 201, 202 of the optical coupler may have symmetrical shapes comprising two symmetrical tapering curves. In such cases, the largest width W2 of the tapered portion, measured at the proximal end of the tapering portion, is the sum of: 2×the difference between x values of P1 and P2 on the graph; and the width W1 of the end face.

In one example, the length of the second tapering portion 202 of the intermediate waveguide 200 is 186 μm, the intermediate waveguide 200 is a Si₃N₄ waveguide, and the second waveguide 300 is a Ge-doped SiO₂ waveguide. In this example, the parameters b and xc have been optimised in order to maximise the energy coupling efficiency between the Si₃N₄ waveguide and Ge-doped SiO₂ waveguide. The calculated values according to numerical simulations in this example are: b=−11 μm⁻¹, xc=0.75 μm, with the nominal computed coupling efficiency of 96.02%. (−0.176 dB). In order to maintain the losses under 3 dB, the parameter b needs to be between −41 μm⁻¹ and −0.5 μm⁻¹, and the parameter xc needs to be between −64 μm and 65 μm.

The curve profiles of one or more of the tapering portions 101, 201, 202 of the optical coupler may preferably be determined according to Equation 1, in other embodiments, the one or more of the tapering portions 101, 201, 202 may have one or more of other types of tapering profiles, such as linear, non-linear, parabolic, exponential and any other type of curved profiles. Preferably, the one or more of the tapering portions 101, 201, 202 may have exponential profile(s). Such exponential profiles may be computed and/or optimised to provide high coupling efficiency, for example, based on Equation 1.

Preferably, as shown in FIG. 1 and FIG. 3, the intermediate waveguide 200 and the second waveguide 300 may be optically and/or physically coupled in a manner to minimise interference from the first waveguide 100. For example, the intermediate waveguide 200 and the second waveguide 300 may be optically and/or physically coupled so that the coupling takes place spaced apart from the first waveguide 100. In such cases, when the optical coupler is viewed from the top (e.g. shown in FIG. 1B), the portion of the optical coupler in which the coupling between the intermediate waveguide 200 and the second waveguide 300 takes place may not overlap with the first waveguide 100. One way to implement such a structure, as shown in the examples of FIG. 1 and FIG. 3, is to design the optical coupler so that the coupling between the intermediate waveguide 200 and the second waveguide 300 takes place spaced apart from the substrate 104 and dielectric layer 106 of the first waveguide 100. In such cases, the first waveguide 100 and the second waveguide 300 may not be formed on the same substrate 104. Optionally, at least a part of the intermediate waveguide 200 may also not be formed on the same substrate 104.

Advantageously, coupling the intermediate waveguide 200 and the second waveguide 300 spaced apart from the first waveguide 100 enables spot-size conversion (e.g. enlargement of the wave field) from the first waveguide to the second waveguide with no or minimal interference from the first waveguide (e.g. without interfering with a Si substrate of a SOI chip).

The optical coupler described above may be fabricated by using a method comprising steps of: providing a first substrate 602; forming a dielectric layer on the first substrate 604; forming a layer of a first waveguide material on the dielectric layer 606; partially etching the layer of the first waveguide material to form a tapering portion 608; providing a second substrate 610; forming a cladding layer on the second substrate 612; forming a layer of an intermediate waveguide material on the cladding layer 614; partially etching the layer of the intermediate waveguide material to form a first tapering portion and a second tapering portion 616; forming a layer of a second waveguide material covering the second tapering portion of the intermediate waveguide and a part of the cladding layer 618; and coupling the first waveguide and the intermediate waveguide so that the distance between the first waveguide and the intermediate waveguide is smaller than the distance between the first waveguide and the second substrate 620.

In some embodiments, a wafer comprising a layer of first waveguide material (e.g. silicon or lithium niobate), a dielectric layer and a substrate may be used to fabricate the optical coupler. In such cases, the thin layer of silicon or lithium niobate is etched to form the first waveguide, therefore, the above steps of: providing a first substrate 602; forming a dielectric layer on the first substrate 604; forming a layer of a first waveguide material on the dielectric layer 606; partially etching the layer of the first waveguide material to form a tapering portion 608; providing a second substrate 610; forming a cladding layer on the second substrate 612; forming a layer of an intermediate waveguide material on the cladding layer 614; partially etching the layer of the intermediate waveguide material to form a first tapering portion and a second tapering portion 616 are replaced with steps of: providing a wafer comprising a layer of first waveguide material, a dielectric layer and a substrate; and etching the layer of the first waveguide material to form a tapering portion.

Optionally, the layer of the first waveguide may be etched to form a portion having a first thickness and a portion having a second thickness, which would result in a rib waveguide structure.

Optionally, the step of coupling the first waveguide and the intermediate waveguide may be performed by attaching the intermediate waveguide to the first waveguide via an adhesive layer. Alternatively, coupling of the first waveguide and the intermediate waveguide may be performed by attaching the intermediate waveguide to the first waveguide by means of one or more releasable connecting means. Such configurations provide an easy way to align the first waveguide and the intermediate waveguide for coupling and also detaching them depending on the user's needs.

Optionally, the step of coupling the first waveguide and the intermediate waveguide may comprise a step of aligning the tapering portion of the first waveguide and the first tapering portion of the intermediate waveguide by using a mask aligner. This provides an additional solution for easily aligning the first waveguide and the intermediate waveguide.

1. An optical coupler comprising:
a first waveguide comprising a tapering portion;
an intermediate waveguide comprising:
a first tapering portion at a first end of the intermediate waveguide, the first tapering portion of the intermediate waveguide being optically coupled to the tapering portion of the first waveguide, and
a second tapering portion at a second end of the intermediate waveguide; and
a second waveguide, wherein the second tapering portion of the intermediate waveguide is optically coupled to the second waveguide.

2. The optical coupler of claim 1, wherein an optical signal propagates from the first waveguide to the second waveguide via the intermediate waveguide.

3. The optical coupler of claim 1, wherein an optical signal propagates from the second waveguide to the first waveguide via the intermediate waveguide.

4. The optical coupler of any of the preceding claims, wherein at least a part of the first waveguide is adjacent to a dielectric layer, at least a part of the dielectric layer being located between the at least a part of the first waveguide and a first substrate.

5. The optical coupler of claim 4, wherein the first substrate comprises silicon.

6. The optical coupler of claim 4 or 5, wherein the first substrate is a part of a chip, the chip having one or more electronic or optical components formed thereon.

7. The optical coupler of any of claims 4 to 6, wherein the dielectric layer comprises one or more of: SiO₂, Si₃N₄, and other dielectric material such as polymer.

8. The optical coupler of any of claims 4 to 7, wherein the dielectric layer is in the form of buried oxide (BOX).

9. The optical coupler of any of the preceding claims, wherein the first waveguide comprises silicon.

10. The optical coupler of any of claims 1-8, wherein the first waveguide comprises lithium niobate.

11. The optical coupler of any of the preceding claims, wherein the first waveguide comprises a first portion having a first thickness and a second portion having a second thickness, the second thickness being greater than the first thickness.

12. The optical coupler of claim 11, wherein the second portion has an elevated surface relative to the first portion.

13. The optical coupler of claim 11 or 12, wherein the second portion has a tapering profile extending toward the second waveguide.

14. The optical coupler of any of claims 11 to 13, wherein the first waveguide is a rib waveguide.

15. The optical coupler of any of the preceding claims, comprising an adhesive layer between at least a part of the first waveguide and at least a part of the intermediate waveguide, wherein the tapering portion of the first waveguide and the first tapering portion of the intermediate waveguide at least partially overlap.

16. The optical coupler of any of the preceding claims, wherein at least a part of the first waveguide and at least a part of the intermediate waveguide are coupled by means of one or more releasable connecting means, wherein the tapering portion of the first waveguide and the first tapering portion of the intermediate waveguide at least partially overlap.

17. The optical coupler of any of the preceding claims, wherein the tapering portion of the first waveguide and the first tapering portion of the intermediate waveguide have the same length.

18. The optical coupler of any of claim 17, wherein the tapering portion of the first waveguide and the first tapering portion of the intermediate waveguide overlap along their lengths.

19. The optical coupler of any of claim 4-18, comprising a spacer layer between the tapering portion of the first waveguide and the first tapering portion of the intermediate waveguide, preferably wherein the spacer layer has a refractive index equal to that of the dielectric layer located adjacent to the first waveguide, and further preferably wherein the spacer layer has a thickness between 0.4 μm and 1.9 μm.

20. The optical coupler of claim 19, wherein the space layer is the adhesive layer of claim 15.

21. The optical coupler of any of the preceding claims, wherein the dimensions and tapering profiles of one or more of the tapering portions of the first and intermediate waveguides are determined to maximise one or more of: an optical coupling efficiency between the first waveguide and the intermediate waveguide, and an optical coupling efficiency between the intermediate waveguide and the second waveguide.

22. The optical coupler of any of the preceding claims, wherein relative positions of the tapering portion of the first waveguide and the first tapering portion of the intermediate waveguide are determined to minimise optical coupling loss between the tapering portion of the first waveguide and the first tapering portion of the intermediate waveguide

23. The optical coupler of claim 22, wherein the dimensions, tapering profiles, and the relative positions of the tapering portion of the first waveguide and the first tapering portion of the intermediate waveguide are determined so that the optical coupling loss between the tapering portion of the first waveguide and the first tapering portion of the intermediate waveguide is lower than 3 dB.

24. The optical coupler of any of the preceding claims, wherein the intermediate waveguide comprises Si₃N₄.

25. The optical coupler of any of the preceding claims, wherein at least a part of the intermediate waveguide is adjacent to one or more cladding layers, at least one of the cladding layer being located between the at least a part of the intermediate waveguide and a second substrate, preferably wherein the cladding layer located between the at least a part of the intermediate waveguide and the second substrate has a thickness greater than 15 μm.

26. The optical coupler of claim 25, wherein the second substrate comprises silicon.

27. The optical coupler of claim 25 or 26, wherein the second substrate, the one or more cladding layer(s), and the intermediate waveguide are packaged as a flip-chip.

28. The optical coupler of any of claims 25 to 27, wherein the cladding layer comprises one or more of: SiO₂, Si₃N₄, and other dielectric material such as polymer.

29. The optical coupler of any of the preceding claims, wherein the refractive index of the first waveguide is higher than that of the intermediate waveguide.

30. The optical coupler of any of the preceding claims, wherein the second waveguide comprises a first portion having a first thickness and a second portion having a second thickness, the second thickness being greater than the first thickness, wherein the second tapering portion of the intermediate waveguide is coupled to the first portion of the second waveguide.

31. The optical coupler of any of claims 25 to 30, wherein at least one of the cladding layers is adjacent to the second tapering portion of the intermediate waveguide and the second waveguide.

32. The optical coupler of any of claims 27 to 31, wherein the flip-chip further comprises the second waveguide.

33. The optical coupler of any of the preceding claims, wherein the second waveguide comprises SiO₂, and at least one type of dopants, such as Ge and P, for increasing the refractive index of the second waveguide.

34. The optical coupler of claim 33, wherein the second waveguide is configured to be coupled to an external optical transmission means, such as an optical fibre, and the type of the dopants and the doping concentration are determined so that the refractive index of the second waveguide has 0.4-0.7% contrast with that of the external optical transmission means.

35. The optical coupler of claim 33 or 34, wherein the dopants are Ge dopants.

36. The optical coupler of claim 33 to 35, wherein the external optical transmission means comprise SiO₂.

37. The optical coupler of any of the preceding claims, wherein the dimensions and tapering profiles of the second tapering portion of the intermediate waveguide are determined to maximise the optical coupling efficiency between the second tapering portion of the intermediate waveguide and the second waveguide.

38. The optical coupler of any of the preceding claims, wherein relative positions of the second tapering portion of the intermediate waveguide and the second waveguide are determined to minimise optical coupling loss between the second tapering portion of the intermediate waveguide and the second waveguide.

39. The optical coupler of claim 38, wherein the dimensions and tapering profiles of the second tapering portion of the intermediate waveguide, and its position relative to the second waveguide are determined so that the optical coupling loss between the second tapering portion of the intermediate waveguide and the second waveguide is lower than 3 dB.

40. The optical coupler of any of claims 2-39, wherein the optical coupler is configured to function as a spot size converter, wherein the optical signal has a first mode in the first waveguide and a second mode in the second waveguide, the first mode being smaller than the second mode.

41. A method for fabricating an optical coupler, the method comprising steps of:
providing a first substrate;
forming a dielectric layer on the first substrate;
forming a layer of a first waveguide material on the dielectric layer;
partially etching the layer of the first waveguide material to form a tapering portion;
providing a second substrate;
forming a cladding layer on the second substrate;
forming a layer of an intermediate waveguide material on the cladding layer;
partially etching the layer of the intermediate waveguide material to form a first tapering portion and a second tapering portion;
forming a layer of a second waveguide material covering the second tapering portion of the intermediate waveguide and a part of the cladding layer; and
coupling the first waveguide and the intermediate waveguide so that the distance between the first waveguide and the intermediate waveguide is smaller than the distance between the first waveguide and the second substrate.

42. The method of claim 41, further comprising a step of etching the layer of the first waveguide to form a portion having a first thickness and a portion having a second thickness, thereby forming a rib waveguide structure.

43. The method of claim 41 or 42, wherein the step of coupling the first waveguide and the intermediate waveguide is performed by attaching the intermediate waveguide to the first waveguide via an adhesive layer.

44. The method of claim 41 or 42, wherein coupling the first waveguide and the intermediate waveguide is performed by attaching the intermediate waveguide to the first waveguide by means of one or more releasable connecting means.

45. The method of any of claims 41 to 44, wherein the step of coupling the first waveguide and the intermediate waveguide comprises a step of aligning the tapering portion of the first waveguide and the first tapering portion of the intermediate waveguide by using a mask aligner.

46. The method of any of claim 44 or 45, wherein the external optical transmission means and/or the second waveguide is pluggable with the first waveguide using the one or more releasable connecting means.

47. The optical coupler of any of claims 16-40, wherein the external optical transmission means and/or the second waveguide is pluggable with the first waveguide using the one or more releasable connecting means.

48. The optical coupler of any of claims 1-40 or 47, wherein the intermediate waveguide and the second waveguide are optically and/or physically coupled so that the coupling takes place spaced apart from the first waveguide.

49. The optical coupler of claim 48, wherein the first waveguide and the second waveguide are not positioned on a same substrate.

50. The optical coupler of claim 48 or 49, wherein the first waveguide and at least a part of the intermediate waveguide are not positioned on the same substrate.

51. The optical coupler of any of claims 1-40 or 47-50, wherein one or more of the tapering portion of the first waveguide, the first tapering portion of the intermediate waveguide, and the second tapering portion of the intermediate waveguide have tapering profiles defined by Y(x) and x, Y(x) corresponding to the direction along the length of the one or more tapered portions and x corresponding to the direction along the width of the same one or more tapered portions;
wherein
$$Y ( x ) = A * {e}^{- b * ( x - xc )} + Yc ;$$
$$A = \frac{{y}_{1} - {y}_{2}}{{e}^{- b * ( {x}_{1} - xc )} - {e}^{- b * ( {x}_{2} - xc )}} ; and$$
$$Yc = {y}_{2} - A * {e}^{- b * ( {x}_{2} - xc )} .$$
